(19) United States
(12) Patent Application Publication
(10) Pub. No.: US 2004/0001587 A1
(43) Pub. Date: Jan. 1, 2004

(54) xDSL interconnecting device and communication system

(75) Inventor: Minoru Dendou, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/064,934

(22) Filed: Aug. 30, 2002

(30) Foreign Application Priority Data
Jul. 1, 2002 (WO) PCT/JP02/06626

(51) Int. Cl. H04M 1/00; H04M 9/00

(52) U.S. Cl. 379/413.02

(57) ABSTRACT

An xDSL interconnecting device for interconnecting the first analog line and the second analog line, includes: the first analog transmit/receive unit, connected to the first analog line, for transmitting an analog signal having the first frequency band to the first analog line and receiving an analog signal having the second frequency band higher than the first frequency band from the first analog line; the second analog transmit/receive unit, connected to the second analog line, for transmitting an analog signal having the second frequency band to the second analog line and receiving an analog signal having the first frequency band from the second analog line; and an interconnecting unit, connected to the first and second transmit/receive units, for interconnecting communication between the first and second analog transmit/receive units.

### CROSS REFERENCE TO RELATED APPLICATIONS

This patent application claims priority from a PCT application No. PCT/JP02/06626 filed on Jul. 1, 2002, the contents of which are incorporated herein by reference.

### BACKGROUND OF INVENTION

1. Field of the Invention

The present invention relates to an xDSL interconnecting device and a communication system. More particularly, the present invention relates to an xDSL interconnecting device that interconnects analog lines through which communication by xDSL is performed.

2. Description of the Related Art

With the recent spread of the use of the Internet, it is desired that high-speed lines for delivering large amount of data such as music data, image data and movie data via the Internet is realized. In accordance with such a demand, xDSL such as ADSL (Asymmetric Digital Subscriber Line) and VDSL (Very high bit rate Digital Subscriber Line) is being widespread.

In a case of VDSL, the maximum transmission rate can be increased to about 50 Mbps. Also, VDSL can be realized by using telephone lines that were already set. Thus, as compared with FTTH (Fiber To The Home) using optical fibers, initial cost and construction cost can be greatly reduced.

However, VDSL has a problem that the maximum transmission distance is about 1.5 km. Thus, although the transmission rate can be increased, VDSL is not suitable for long-distance transmission.

### SUMMARY OF INVENTION

Therefore, it is an object of the present invention to provide an xDSL interconnecting device and a communication system, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an xDSL interconnecting device for interconnecting a first analog line and a second analog line, includes: a first analog transmit/receive unit, connected to the first analog line, operable to transmit an analog signal having a first frequency band to the first analog line and to receive an analog signal having a second frequency band higher than the first frequency band from the first analog line; a second analog transmit/receive unit, connected to the second analog line, operable to transmit an analog signal having the second frequency band to the second analog line and to receive an analog signal having the first frequency band from the second analog line; and an interconnecting unit, connected to the first analog transmit/receive unit and the second analog transmit/receive unit, operable to interconnect communication between the first analog transmit/receive unit and the second transmit/receive unit.

The first analog transmit/receive unit may include: a first combine/separate circuit operable to separate a transmitted signal and a received signal that are superposed on the first analog line from each other; a first AD converter operable to convert an analog signal obtained from the first combine/separate circuit to a digital signal to supply the digital signal to the interconnecting unit; and a first DA converter operable to convert a digital signal obtained from the interconnecting unit to an analog signal to supply the analog signal to the first combine/separate circuit, and the second analog transmit/receive unit may include: a second combine/separate circuit operable to separate a transmitted signal and a received signal that are superposed on the second analog line from each other; a second AD converter operable to convert an analog signal obtained from the second combine/separate circuit to a digital signal to supply the digital signal to the interconnecting unit; and a second DA converter operable to convert a digital signal obtained from the interconnecting unit to an analog signal to supply the analog signal to the second combine/separate circuit.

A plurality of first analog transmit/receive units and a plurality of second analog transmit/receive units may be provided, and the interconnecting unit may control routings between the plurality of first analog transmit/receive units and the plurality of second analog transmit/receive units.

The first analog transmit/receive unit may transmit an analog signal having a first partial frequency band of the first frequency band and receives an analog signal having a second partial frequency band of the second frequency band, and the second analog transmit/receive unit may transmit data received by the first analog transmit/receive unit in the second partial frequency band, as an analog signal having a third partial frequency band of the second frequency band and receive data to be transmitted by the first analog transmit/receive unit in the first partial frequency band, as an analog signal having a fourth partial frequency band of the first frequency band.

The first analog transmit/receive unit and the second analog transmit/receive unit may be provided on different circuit boards, respectively.

A plurality of first analog transmit/receive units may be respectively provided on different circuit boards; a plurality of second analog transmit/receive units may be respectively provided on different circuit boards; and the circuit boards where the first analog transmit/receive units may be provided and the circuit boards where the second analog transmit/receive units are provided are alternately arranged.

The xDSL interconnecting device may further include: a power supply operable to supply power to the first analog transmit/receive unit and the second analog transmit/receive unit; and a first noise filter provided between the power supply and the first analog transmit/receive unit.

The xDSL interconnecting device may further include a second noise filter provided between the power supply and the second analog transmit/receive unit.

The xDSL interconnecting device may further include a low-pass filter, provided on wiring connecting the first analog line and the second analog line, operable to supply an analog signal transmitted through the first analog line to the second analog line after reducing high frequency components thereof and to supply an analog signal transmitted through the second analog line to the first analog line after reducing high frequency components thereof.

The xDSL interconnecting device may further include a first splitter provided between the first analog line and the first analog transmit/receive unit; and a second splitter provided between the second analog line and the second analog transmit/receive unit, and wherein the first splitter extracts, from an analog signal obtained via the first analog line, an analog signal having a third frequency band lower than the second frequency band, supplies an analog signal having the second frequency band to the first analog transmit/receive unit, supplies the analog signal having the third frequency band to the second splitter, and combines an analog signal transmitted by the first analog transmit/receive unit with an analog signal obtained from the second splitter to output them to the first analog line, and the second splitter extracts from, an analog signal obtained from the second analog line, an analog signal having the third frequency band lower than the first frequency band, supplies an analog signal having the first frequency band to the second analog transmit/receive unit, supplies the analog signal having the third frequency band to the first splitter, and combines an analog signal transmitted by the second analog transmit/receive unit with an analog signal obtained from the first splitter to output them to the second analog line.

The xDSL interconnecting device may further comprise a digital transmit/receive unit, connected to a digital line, operable to transmit/receive a digital signal, wherein the interconnecting unit is further connected to the digital transmit/receive unit and interconnects communication between the first analog transmit/receive unit and the digital transmit/receive unit.

According to the second aspect of the present invention, a communication system comprises: an xDSL concentrator operable to convert a received digital signal to an analog signal to output the analog signal; an xDSL interconnecting device operable to receive from a first analog line the analog signal output by the xDSL concentrator to output the analog signal to a second analog line; and an xDSL converter operable to convert the analog signal output by the xDSL interconnecting device to a digital signal to transmit the digital signal to a users terminal, wherein the xDSL interconnecting device includes: a first analog transmit/receive unit, connected to the first analog line, operable to transmit an analog signal having a first frequency band to the first analog line and to receive an analog signal having a second frequency band higher than the first frequency band from the first analog line; a second analog transmit/receive unit, connected to the second analog line, operable to transmit an analog signal having the second frequency band to the second analog line and to receive an analog signal having the first frequency band from the second analog line; and an interconnecting unit, connected to the first analog transmit/receive unit and the second analog transmit/receive unit, operable to interconnect communication between the first analog transmit/receive unit and the second analog transmit/receive unit.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 illustrates an exemplary arrangement of a communication system 10 according to an embodiment of the present invention.

FIG. 2 illustrates an exemplary arrangement of a VDSL interconnecting device 100a according to the embodiment of the present invention.

FIG. 3 shows an example of frequency bands respectively used by analog transmit/receive units 102a and 102b.

### DETAILED DESCRIPTION

The invention will now be described based on the preferred embodiments, which do not intend to limit the scope of the present invention, but exemplify the invention. All of the features and the combinations thereof described in the embodiment are not necessarily essential to the invention.

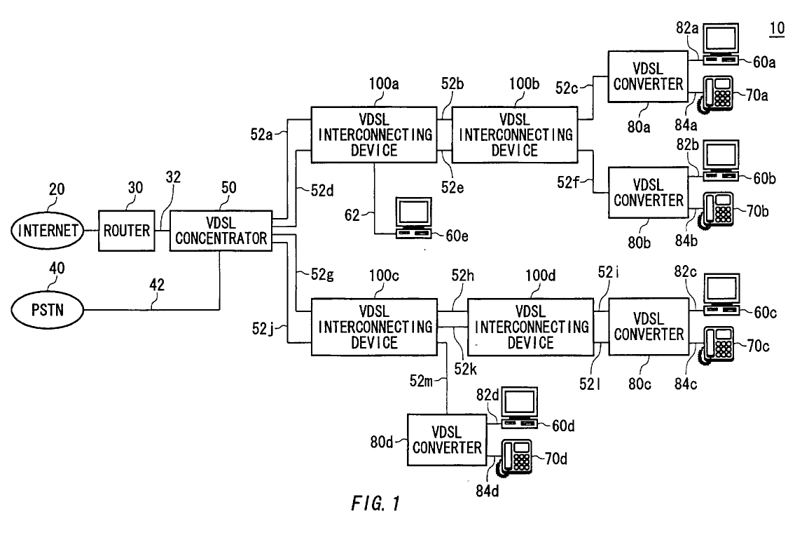

FIG. 1 illustrates an exemplary arrangement of a communication system 10 according to an embodiment of the present invention. The communication system 10 realizes a long-distance transmission in VDSL which realizes high-speed transmission by using analog lines such as telephone lines, by using a VDSL interconnecting device which interconnects the analog lines with each other.

The communication system 10 includes a router 30 that can be connected to the Internet 20; a VDSL concentrator 50 that can be connected to the router 30 and a PSTN (Public Switched Telephone Network) 40; a plurality of VDSL converters 80a, 80b, 80c and 80d to be respectively connected to PCs 60a, 60b, 60c and 60d and telephones 70a, 70b, 70c and 70d; and VDSL interconnecting devices 100a, 100b, 100c and 100d which interconnect the VDSL concentrator 50 and the VDSL converters 80a, 80b, 80c and 80d. The VDSL concentrator 50 is an exemplary xDSL concentrator of the present invention; the VDSL interconnecting devices 100a, 100b, 100c and 100d are an exemplary xDSL converter of the present invention; and the PCs 60a, 60b, 60c and 60d are an exemplary users terminal.

The VDSL concentrator 50 is connected to the router 30 via a digital line 32 such as an Ethernet cable, and converts a digital signal received from the router 30 to an analog signal so as to transmit the analog signal to the VDSL converters 80a, 80b, 80c and 80d. In this transmission, the VDSL concentrator 50 uses a band from 900 kHz to 3.5 MHz, for example.

Moreover, the VDSL concentrator 50 transmits an analog signal received from the PSTN 40 via an analog line 42 such as a telephone line, to the VDSL converters 80a, 80b, 80c and 80d. In this transmission, the VDSL concentrator 50 uses a band of 4 kHz or less, for example, for transmitting the analog signal to the VDSL converters 80a, 80b, 80c and 80d.

In addition, the VDSL concentrator 50 receives an analog signal having a band of 4 kHz or less and an analog signal having a band from 4.3 MHz to 7.9 MHz, for example. The VDSL concentrator 50 then separates the analog signal having the band of 4 kHz or less and the analog signal having the band from 4.3 MHz to 7.9 MHz from each other, and thereafter transmits the analog signal of 4 kHz or less to the PSTN 40 and also transmits the other analog signal to the router 30 after converting it to a digital signal.

The VDSL converters 80a, 80b, 80c and 80d are connected to the VDSL concentrator 50 via the VDSL interconnecting devices 100a, 100b, 100c and 100d and analog lines 52a-52m. The VDSL converters 80a, 80b, 80c and 80d receive from the VDSL concentrator SO an analog signal having a band of 4 kHz or less and an analog signal having a band from 900 kHz to 3.5 MHz, for example. Each of the VDSL converters 80a, 80b, 80c and 80d then separates those analog signals from each other and thereafter transmits the analog signal having the band of 4 kHz or less to an associated one of the telephones 70a, 70b, 70c and 70d and also transmits the other analog signal to an associated one of the PCs 60a, 60b, 60c and 60d after converting it to an digital signal.

Moreover, each of the VDSL converters 80a, 80b, 80c and 80d transmits an analog signal received from the associated one of the PCs 60a, 60b, 60c and 60d via a digital line 82a, 82b, 82c or 82d such as an Ethernet cable, to the VDSL concentrator 50. In this transmission, each VDSL converter uses the band of 4 kHz or less, for example, for transmitting the analog signal to the VDSL concentrator 50.

Furthermore, each of the VDSL converters 80a, 80b, 80c and 80d transmits to the VDSL concentrator 50 an analog signal received from the associated one of the telephones 70a, 70b, 70c and 70d via an analog line 84a, 84b, 84c or 84d such as a telephone line. In this transmission, each of the VDSL converters 80a, 80b, 80c and 80d uses a band of 4 kHz or less, for example.

The VDSL interconnecting devices 100a, 100b, 100c and 100 are connected to any of the VDSL concentrator 50 and VDSL converters 80a, 80b, 80c and 80d via the analog lines 52a-52m. The VDSL interconnecting devices 100a, 100b, 100c and 100 may be connected by daisy chain connection or tree connection.

Each of the VDSL interconnecting devices 100a, 100b, 100c and 100d transmits an analog signal received from the VDSL concentrator 50 side to a corresponding VDSL converter side. In this transmission, the VDSL interconnecting devices 100a, 100b, 100c and 100d use a band from 900 kHz to 3.5 MHz, for example. Also, each of the VDSL interconnecting devices 100a, 100b, 100c and 100d transmits an analog signal received from the corresponding VDSL converter side to the VDSL concentrator 50 side, In this transmission, the VDSL interconnecting devices 100a, 100b, 100c and 100d use a band from 4.3 MHz to 7.9 MHz, for example.

Moreover, each of the VDSL interconnecting devices 100a, 100b, 100c and 100d may be directly connected to the associated PC via a digital line such as an Ethernet cable so that the VDSL interconnecting device transmit an analog signal received from the VDSL concentrator 50 to the associated PC after converting it into a digital signal and transmit a digital signal received from the associated PC to the VDSL concentrator 50 after converting it to an analog signal. For example, the VDSL interconnecting device 100a is directly connected to the PC 60e via the digital line 62; converts an analog signal received from the VDSL concentrator 50 via the analog line 52a or 52d to a digital signal; and transmits the digital signal to the PC 60e via the digital line 62. Also, the VDSL interconnecting device 100a converts the analog signal received from the VDSL interconnecting device 100b via the analog line 52b or 52e to a digital signal and transmits the digital signal to the PC 60e via the digital line 62.

In addition, each of the VDSL interconnecting devices 100a, 100b, 100c and 100d may be connected to an access point of a wireless LAN via a digital line such as an Ethernet cable. Then, each VDSL interconnecting device may transmit a digital signal to a handheld PC via the digital line and the access point.

The VDSL interconnecting devices 100a, 100b, 100c and 100d may have a routing function such as a spanning tree function, so as to allow dynamic change of destination. For example, the VDSL interconnecting device 100a may output the analog signal received via the analog line 52a to either the analog line 52b, the analog line 52e or the digital line 62. Moreover, in a case where the analog line 52e has any trouble, the VDSL interconnecting device 100a may output an analog signal to be transmitted to the VDSL converter 80a and an analog signal to be transmitted to the VDSL converter 80b to the analog line 52e.

Furthermore, each of the VDSL interconnecting devices 100a, 100b, 100c and 100d may have an Ethernet layer 2 switching function that realizes forwarding based on learning of an MAC address, so as to output data obtained from the analog line or digital line to an analog or digital line that corresponds to a destination MAC address of that data.

The VDSL concentrator 50, the VDSL converters 80a, 80b, 80c and 80d and the VDSL interconnecting devices 100a, 100b, 100c and 100d may have IP addresses respectively assigned thereto so as to have an ICMP (Internet Control Message Protocol) function. This enables diagnostics for a possible trouble in the VDSL concentrator 50, the VDSL converters 80a, 80b, 80c and 80d and the VDSL interconnecting devices 100a, 100b, 100c and 100d.

As described above, by providing the VDSL interconnecting devices 100a, 100b, 100c and 100d so as to interconnect the analog lines, the long-distance transmission can be realized by using VDSL that enables high-speed transmission. Moreover, since the telephone lines that have been set already can be used, the communication system 10 for allowing the high-speed transmission and the long-distance transmission can be configured with a reduced construction period and a reduced cost.

For example, if the VDSL interconnecting device of the present embodiment is installed in each of signal boxes that are arranged on a railroad at intervals of 500 meters, so as to form the communication system 10 of the present embodiment on the whole railroad, calls and data communication between stations can be performed by using VDSL.

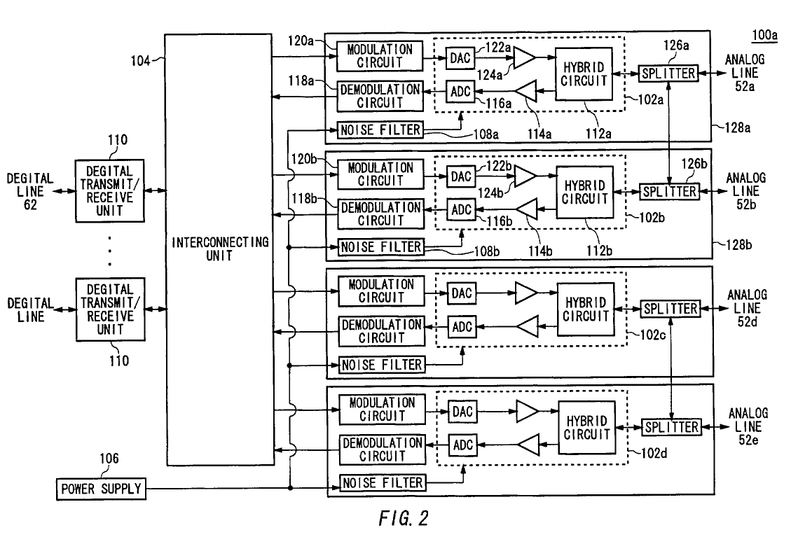

FIG. 2 illustrates an exemplary arrangement of the VDSL interconnecting device 100a according to the present embodiment. Although the following description will be made referring to the VDSL interconnecting device 100a as an example, the other VDSL interconnecting devices 100b, 100c and 100d have similar arrangements to that of the VDSL interconnecting device 100a.

The VDSL interconnecting device 100a includes an analog signal transmit/receive unit 102a that is connected to the analog line 52a, transmits an analog signal having the first frequency band (900 kHz to 3.5 MHz, for example) to the analog line 52a and receives an analog signal having the second frequency band (4.3 MHz to 7.9 MHz, for example) higher than the first frequency band from the analog line; an analog signal transmit/receive unit 102b that is connected to the analog line 52b, transmits an analog signal having the second frequency band to the analog line 52b and receives an analog signal having the first frequency band from the analog line 52b; an interconnecting unit 104 that interconnects communication between the analog transmit/receive units 102a and 102b; a demodulation circuit 118a that demodulates a digital signal received from the analog transmit/receive unit 102a to supply the demodulated signal to the interconnecting unit 104; a modulation circuit 120a that modulates a digital signal obtained from the interconnecting unit 104 in the first frequency band to supply the modulated signal to the analog transmit/receive unit 102a; a demodulation circuit 118b that demodulates a digital signal obtained by the analog transmit/receive unit 102b to supply the demodulated signal to the interconnecting unit 104; and a modulation circuit 120b that modulates a digital signal obtained from the interconnecting unit 104 in the second frequency band to supply the modulated signal to the analog transmit/receive unit 102b.

The analog transmit/receive unit 102a includes a hybrid circuit 12a, that is an exemplary first combine/separate circuit, that combines and separates a transmitted signal and a received signal superposed on the analog line 52a; an amplifying circuit 114a that amplifies an analog signal having the second frequency band obtained from the hybrid circuit 112a; an AD converter 116a that converts the analog signal amplified by the amplifying circuit 114a to a digital signal so as to supply the digital signal to the demodulation circuit 118a; a DA converter 122a that converts a digital signal modulated by the modulation circuit 120a to an analog signal; and an amplifying circuit 124a that amplifies the analog signal obtained by conversion by the DA converter 122a so as to supply the amplified signal to the hybrid circuit 112a.

The analog transmit/receive unit 102b includes a hybrid circuit 112b, that is an exemplary first combine/separate circuit, that combines and separates a transmitted signal and a received signal superposed on the analog line 52b; an amplifying circuit 114b that amplifies an analog signal having the first frequency band obtained from the hybrid circuit 112b; an AD converter 116b that converts the analog signal amplified by the amplifying circuit 114b to a digital signal so as to supply the digital signal to the demodulation circuit 118b; a DA converter 122b that converts the digital signal modulated by the modulation circuit 120b to an analog signal; and an amplifying circuit 124b that amplifies the analog signal obtained by conversion by the DA converter 122b so as to supply the amplified signal to the hybrid circuit 112b.

Moreover, the VDSL interconnecting device 100a includes a power supply 106 that supplies power to analog circuits such as the analog transmit/receive units 102a and 102b; a noise filter 108a provided between the power supply 106 and the analog transmit/receive unit 102a and a noise filter 108b provided between the power supply 106 and the analog transmit/receive unit 102b.

The noise filters 108a and 108b reduce electrical noises between the analog transmit/receive units 102a and 102b. In other words, the noise filters 108a and 108b can reduce interference between the hybrid circuits 112a and 112b via wiring connected to the analog transmit/receive units 102a and 102b. Even in a case where a receiving frequency of the analog transmit/receive unit 102a is identical to a transmitting frequency of the analog transmit/receive unit 102b or a transmitting frequency of the analog transmit/receive unit 102a is identical to a receiving frequency of the analog transmit/receive unit 102b, adverse effects of one of the analog transmit/receive units 102a and 102b on the other can be reduced by providing the noise filters 108a and 108b.

The power supply 106 may supply power digital circuits such as the modulation circuits 120a and 120b and the demodulation circuits 118a and 118b. In this case, the power supply 106 may be connected to the analog circuits and digital circuits on a plurality of circuit boards from the outside of the circuit boards, respectively, so as to supply the power to the respective analog circuits and digital circuits provided on the circuit boards.

Moreover, the power supply 106 may be connected to a plurality of circuit boards from the outside of the circuit boards, respectively, so that the power supply 106 supply digital power to the digital circuits respectively provided on the circuit boards and supply analog power to the analog circuits respectively provided on the circuit boards via the noise filter 108a or 108b.

In addition, the VDSL interconnecting device 100a includes a splitter 126a provided between the analog line 52a and the analog transmit/receive unit 102a and a splitter 126b provided between the analog line 52b and the analog transmit/receive unit 102b.

The splitter 126a extracts an analog signal having the third frequency band (frequency band for calls of 4 kHz or less, for example) lower than the second frequency band from the analog signal obtained via the analog line 52a. The splitter 126a then supplies the analog signal having the second frequency band to the analog transmit/receive unit 102a and also supplies the analog signal having the third frequency band to the splitter 126b. Moreover, the splitter 126a combines an analog signal having the first frequency band transmitted by the analog transmit/receive unit 102a with the analog signal having the third frequency band obtained from the splitter 126b so as to output the combined signal to the analog line 52a. In other words, the splitter 126a combines and separates an analog signal of the data communication and an analog signal of the call.

The splitter 126b extracts an analog signal having the third frequency band lower than the first frequency band from the analog signal obtained via the analog line 52b. The splitter 126b then supplies an analog signal having the first frequency band to the analog transmit/receive unit 102b and also supplies the analog signal having the third frequency band to the splitter 126a. Moreover, the splitter 126b combines the analog signal having the second frequency band transmitted by the analog transmit/receive unit 102b with the analog signal having the third frequency band obtained from the splitter 126a so as to output the combined signal to the analog line 52b. In other words, the splitter 126b combines and separates an analog signal of the data communication and an analog signal of the call.

The splitters 126a and 126b are an exemplary low-pass filter, and are provided on the wiring connecting the analog line 52a and the analog line 52b. The splitters 126a and 126b reduce high frequency components of the analog signal transmitted through the analog line 52a so as to supply that analog signal to the analog line 52b, while reducing high frequency components of the analog signal transmitted through the analog line 52b so as to supply that analog signal to the analog line 52a.

As described above, since the splitters 126a and 126b or the low-pass filters are provided, the analog signal having the third frequency band that is received via the analog line 52a or 52b, that is, the analog signal of the call can be transmitted via the analog line 52b or 52a without converting it to the digital signal. Thus, real time audio communication can be ensured.

Furthermore, the VDSL interconnecting unit 100a includes a digital transmit/receive unit 110, to which a digital line such as an Ethernet cable is connected, for transmitting and receiving a digital signal; a plurality of analog transmit/receive units 102c each of which has the same arrangement as that of the analog transmit/receive unit 102a; and a plurality of analog transmit/receive units 102d each having the same arrangement as that of the analog transmit/receive unit 102b.

The interconnecting unit 104 controls routings between the analog transmit/receive units 102a, 102b, 102c and 102d. The interconnecting unit 104 may supply data obtained by the analog transmit/receive unit 102 in form of an analog signal having the second frequency band, to the analog transmit/receive unit 102c while the analog transmit/receive unit 102c transmits data obtained from the interconnecting unit 104, as the analog signal having the second frequency band. Also, the interconnecting unit 104 may supply the data obtained by the analog transmit/receive unit 102a in form of the analog signal having the second frequency band, to the analog transmit/receive unit 102d, while the analog transmit/receive unit 102d transmits the data obtained from the interconnecting unit 104, as the analog signal having the first frequency band.

The interconnecting unit 104 is also connected to the digital transmit/receive unit 110, and interconnects communication between the analog transmit/receive units 102a-102d and the digital transmit/receive unit 110 and controls routings. The VDSL interconnecting device 100a may include a plurality of digital transmit/receive units 110. In this case, the interconnecting unit 104 may interconnect communication between the digital transmit/receive units 110 and control the routings.

The VDSL interconnecting device 100a also includes a circuit board 128a where the analog transmit/receive unit 102a is provided and a circuit board 128b where the analog transmit/receive unit 102b is provided. It is preferable that the analog transmit/receive unit 102a and the analog transmit/receive unit 102b be provided on different circuit boards so as to be away from each other. Moreover, a plurality of analog transmit/receive units 102c each having the same arrangement as that of the analog transmit/receive unit 102a are preferably arranged on different circuit boards, respectively. Similarly, a plurality of analog transmit/receive units 102d each having the same arrangement as that of the analog transmit/receive unit 102b are preferably provided on different circuit boards, respectively. Furthermore, it is preferable that the circuit boards where the analog transmit/receive circuits 102c are respectively provided and the circuit boards where the analog transmit/receive circuits 102d are respectively provided are alternately arranged.

As described above, by providing the analog transmit/receive unit 102a and the analog transmit/receive unit 102b on the different circuit boards, respectively, the interference between the hybrid circuit 112a and the hybrid circuit 112b can be reduced even in a case where the receiving frequency of the analog transmit/receive unit 102a is identical to the transmitting frequency of the analog transmit/receive unit 102b or the transmitting frequency of the analog transmit/receive unit 102a is identical to the receiving frequency of the analog transmit/receive unit 102b.

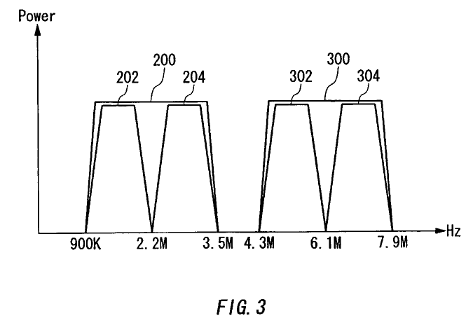

FIG. 3 shows an example of the frequency bands respectively used by the analog transmit/receive units 102a and 102b.

The frequency band of the analog signal received by the analog transmit/receive unit 102a may be different from that of the analog signal transmitted by the analog transmit/receive unit 102b. Also, the frequency band of the analog signal transmitted by the analog transmit/receive unit 102a may be different from that of the analog signal received by the analog transmit/receive unit 102b. In other words, a demodulation frequency of the demodulation circuit 118a may be different from a modulation frequency of the modulation circuit 120b; and a demodulation frequency of the demodulation circuit 118b may be different from a modulation frequency of the modulation circuit 120a.

As shown in FIG. 3, the analog transmit/receive unit 102a transmits an analog signal having the first partial frequency band 202 included in the first frequency band 200 and receives an analog signal having the second partial frequency band 302 included in the second frequency band 300. The analog transmit/receive unit 102b transmits an analog signal having the third partial frequency band 304 included in the second frequency band 300 and receives an analog signal having the fourth partial frequency band 204 included in the first frequency band 200.

For example, the analog transmit/receive unit 102a transmits an analog signal having a band 202 from 900 kHz to 2.2 MHz and receives an analog signal having a band from 4.3 MHz to 6.1 MHz. The analog transmit/receive unit 102b transmits an analog signal having a band 304 from 6.1 MHz to 7.9 MHz and receives an analog signal having a band 204 from 2.2 MHz to 7.9 MHz. That is, the frequency bands respectively used by the analog transmit/receive units 102a and 102b may be made different by reducing the bandwidths of the bands respectively used by the analog transmit/receive units 102a and 102b so as to reduce the communication rates.

As described above, by making the frequency bands of the transmitting by the analog transmit/receive unit 102a, the receiving by the analog transmit/receive unit 102a, the transmitting by the analog transmit/receive unit 102b and the receiving by the analog transmit/receive unit 102b different from one another, interference between signals can be prevented in the transmitting and receiving by the analog transmit/receive units 102a and 102b, thereby providing the data communication with high quality.

As is apparent from the above, according to the present invention, an xDSL interconnecting device which realizes high-speed transmission and long-distance transmission by using analog lines can be provided.

Although the present invention has been described by way of exemplary embodiments, it should be understood that those skilled in the art might make many changes and substitutions without departing from the spirit and the scope of the present invention which is defined only by the appended claims.

1. An xDSL interconnecting device for interconnecting a first analog line and a second analog line, comprising:
a first analog transmit/receive unit, connecting to said first analog line, operable to transmit an analog signal having a first frequency band to said first analog line and to receive an analog signal having a second frequency band higher than said first frequency band from said first analog line;
a second analog transmit/receive unit, connecting to said second analog line, operable to transmit an analog signal having said second frequency band to said second analog line and to receive an analog signal having said first frequency band from said second analog line; and
an interconnecting unit, connected to said first analog transmit/receive unit and said second analog transmit/receive unit, operable to interconnect communication between said first analog transmit/receive unit and said second transmit/receive unit.

2. An xDSL interconnecting device as claimed in claim 1, wherein said first analog transmit/receive unit comprises:
a first combine/separate circuit operable to separate a transmitted signal and a received signal that are superposed on said first analog line from each other;
a first AD converter operable to convert an analog signal obtained from said first combine/separate circuit to a digital signal to supply said digital signal to said interconnecting unit; and
a first DA converter operable to convert a digital signal obtained from said interconnecting unit to an analog signal to supply said analog signal to said first combine/separate circuit, and
wherein said second analog transmit/receive unit includes:
a second combine/separate circuit operable to separate a transmitted signal and a received signal that are superposed on said second analog line from each other;
a second AD converter operable to convert an analog signal obtained from said second combine/separate circuit to a digital signal to supply said digital signal to said interconnecting unit; and
a second DA converter operable to convert a digital signal obtained from said interconnecting unit to an analog signal to supply said analog signal to said second combine/separate circuit.

3. An xDSL interconnecting device as claimed in claim 1, wherein a plurality of first analog transmit/receive units and a plurality of second analog transmit/receive units are provided, and
said interconnecting unit controls routings between said plurality of first analog transmit/receive units and said plurality of second analog transmit/receive units.

4. An xDSL interconnecting device as claimed in claim 1, wherein said first analog transmit/receive unit transmits an analog signal having a first partial frequency band of said first frequency band and receives an analog signal having a second partial frequency band of said second frequency band, and
said second analog transmit/receive unit transmits data received by said first analog transmit/receive unit in said second partial frequency band, as an analog signal having a third partial frequency band of said second frequency band and receives data to be transmitted by said first analog transmit/receive unit in said first partial frequency band, as an analog signal having a fourth partial frequency band of said first frequency band.

5. An xDSL interconnecting device as claimed in claim 1, wherein said first analog transmit/receive unit and said second analog transmit/receive unit are provided on different circuit boards, respectively.

6. An xDSL interconnecting device as claimed in claim 1, wherein a plurality of first analog transmit/receive units are respectively provided on different circuit boards,
a plurality of second analog transmit/receive units are respectively provided on different circuit boards, and
said circuit boards where said first analog transmit/receive units are provided and said circuit boards where said second analog transmit/receive units are provided are alternately arranged.

7. An xDSL interconnecting device as claimed in claim 1, further comprising:
a power supply operable to supply power to said first analog transmit/receive unit and said second analog transmit/receive unit; and
a first noise filter provided between said power supply and said first analog transmit/receive unit.

8. An xDSL interconnecting device as claimed in claim 7, further comprising a second noise filter provided between said power supply and said second analog transmit/receive unit.

9. An xDSL interconnecting device as claimed in claim 1, further comprising a low-pass filter, provided on wiring connecting said first analog line and said second analog line, operable to supply an analog signal transmitted through said first analog line to said second analog line after reducing high frequency components thereof and to supply an analog signal transmitted through said second analog line to said first analog line after reducing high frequency components thereof.

10. An xDSL interconnecting device as claimed in claim 1, further comprising a first splitter provided between said first analog line and said first analog transmit/receive unit; and
a second splitter provided between said second analog line and said second analog transmit/receive unit, and wherein
said first splitter extracts, from an analog signal obtained via said first analog line, an analog signal having a third frequency band lower than said second frequency band, supplies an analog signal having said second frequency band to said first analog transmit/receive unit, supplies said analog signal having said third frequency band to said second splitter, and combines an analog signal transmitted by said first analog transmit/receive unit with an analog signal obtained from said second splitter to output them to said first analog line, and
said second splitter extracts from, an analog signal obtained from said second analog line, an analog signal having said third frequency band lower than said first frequency band, supplies an analog signal having said first frequency band to said second analog transmit/receive unit, supplies said analog signal having said third frequency band to said first splitter, and combines an analog signal transmitted by said second analog transmit/receive unit with an analog signal obtained from said first splitter to output them to said second analog line.

11. An xDSL interconnecting device further comprising a digital transmit/receive unit, connected to a digital line, operable to transmit/receive a digital signal, wherein
said interconnecting unit is further connected to said digital transmit/receive unit and interconnects communication between said first analog transmit/receive unit and said digital transmit/receive unit.

12. A communication system comprising:
an xDSL concentrator operable to convert a received digital signal to an analog signal to output said analog signal;
an xDSL interconnecting device operable to receive from a first analog line said analog signal output by said xDSL concentrator to output said analog signal to a second analog line; and
an xDSL converter operable to convert said analog signal output by said xDSL interconnecting device to a digital signal to transmit said digital signal to a users terminal, wherein
said xDSL interconnecting device includes:
a first analog transmit/receive unit, connected to said first analog line, operable to transmit an analog signal having a first frequency band to said first analog line and to receive an analog signal having a second frequency band higher than said first frequency band from said first analog line;
a second analog transmit/receive unit, connected to said second analog line, operable to transmit an analog signal having said second frequency band to said second analog line and to receive an analog signal having said first frequency band from said second analog line; and
an interconnecting unit, connected to said first analog transmit/receive unit and said second analog transmit/receive unit, operable to interconnect communication between said first analog transmit/receive unit and said second analog transmit/receive unit.
